(19) United States
(12) Patent Application Publication
(10) Pub. No.: US 2005/0237614 A1
(43) Pub. Date: Oct. 27, 2005

(54) Diffractive optical element and method of manufacture of the same

(75) Inventors: Masaaki Nakabayashi, Yokohama-shi (JP); Junji Terada, Tokyo (JP); Senichi Hayashi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/157,986

(22) Filed: Jun. 22, 2005

Related U.S. Application Data
(62) Division of application No. 09/401,660, filed on Sep. 23, 1999.

(30) Foreign Application Priority Data
Sep. 24, 1998 (JP) 287294/1998
Sep. 3, 1999 (JP) 250851/1999

(51) Int. Cl. G02B 27/44

(52) U.S. Cl. 359/565

(57) ABSTRACT

A diffractive optical element having plural diffraction grating surfaces accumulated, wherein a pair of diffraction grating surfaces are positioned so that a protrusion and/or a recess formed on an outside of one diffraction grating surface engages with a recess and/or a protrusion formed on an outside of the other diffraction grating surface, and wherein the pair of diffraction grating surfaces are defined on materials having different refractive indices and different dispersions and being formed into a kinoform, or a shape and a height of blazed or binary, close to it, such that a largest optical path difference to be applied to light rays passing through the diffraction grating surfaces with respect to plural wavelengths becomes equal to a multiple, by an integral number, of the wavelength.

### FIELD OF THE INVENTION AND RELATED ART

This invention relates to a diffractive optical element and method of manufacture of the same.

Conventionally, the correction of chromatic aberration of an optical system is made by using a combination of optical elements made of glass materials which are different in dispersion. In place of a dioptric system such as a lens, a diffractive optical system may be used therefor (“SPIE”, Vol. 1354, Nos. 24-37).

Where a diffractive surface is to be added to an optical system which is designed for use with broadband light such as light of visible region, it is important that the diffraction efficiency, with respect to the design order, of the diffractive surface in the wavelength region to be used is kept high. Otherwise, lights of orders other than the design order have a large diffraction angle, increasing with the difference in diffraction order, such that the deviation of focal distance becomes large. Upon an image plane, it appears as defocus and, when a high luminance light source is there, side lobes will be produced in the image.

Japanese Laid-Open Patent Application, Laid-Open No. 133149/1998 and Japanese Laid-Open Patent Application, Laid-Open No. 127322/1997 show a diffractive optical element with a laminated structure of double-layer diffraction gratings, when used in an optical system, may increase the diffraction efficiency of the light, at the design order, within a wavelength region to be used and, therefore, it may decrease the diffraction efficiency of the light of orders other than the design order. Use of such diffractive optical element will therefore be effective to improve the quality in image and in information. However, such diffractive optical element is difficult to manufacture and it needs complicated and expensive processes.

In consideration of the above, a diffractive optical element having a multilayered structure, having two or more layers, may be manufactured in accordance with a photolithographic process which is employed in semiconductor device manufacturing processes. According to such photolithographic process, a photosensitive resin called “photoresist” is patterned into a fine pattern through an exposure operation and a development operation and, thereafter, an etching operation is made, whereby a fine photoresist pattern is transferred to a substrate.

FIGS. 1A-1J are schematic and sectional views for explaining manufacturing processes for a diffractive optical element with diffraction grating of eight-level step-like structure according to the photolithographic method described above. In FIG. 1A, a photoresist 1 is applied to a substrate 1 by using a spinner, and then, light L is projected thereto to perform patterning exposure. In FIG. 1B, a development operation, a rinsing treatment and a post-baking treatment are performed. In FIG. 1C, an etching operation is made, and then, a washing operation is performed to remove the remaining photoresist 2. By this, a two-level step-like structure is produced. In FIGS. 1D-1F, similar operations as in FIGS. 1A-1C are repeated, whereby a four-level step-like structure is produced. Further, by repeating operations in FIGS. 1G-1I, an eight-level step-like structure such as shown in FIG. 1J is completed.

A diffractive optical element of dual-layer structure can be produced by use of a mold. FIGS. 2A-2I are schematic and sectional views, showing the processes for manufacture of such diffractive optical element of dual-layer structure. In FIG. 2A, an organic coating material 4 is put on a quartz glass substrate 3, and a first mold 5 of quartz glass material is placed thereon. An ultraviolet radiation is projected thereto, whereby a step-like structure of the organic coating material 4 as shown in FIG. 2B is produced. Subsequently, an ion etching operation is made in FIG. 2C, whereby a diffraction grating 6 of quartz glass material is produced as shown in FIG. 2D.

In FIG. 2E, a TiO₂ film 7 is formed on the quartz glass diffraction grating 6, and in FIG. 2F, an organic coating material 4 is put on the TiO₂ film 7. Further, a second mold 8 of quartz glass material, having a step-like shape formed in inverse direction relative to the first mold 5, is put on it. An ultraviolet radiation is then projected thereto, whereby a step-like structure of the organic coating material 4 such as shown in FIG. 2G is produced. In FIG. 2H, an ion etching operation is made again, whereby a high dispersion diffraction grating 9 of TiO₂ film is formed on the quartz glass diffraction grating 6.

If, however, there occurs an unexpected deviation between diffraction gratings to be accumulated, the diffraction efficiency of light of the order or orders different from the design order substantially increases, which causes considerable deterioration of the image quality. It is therefore necessary to adjust the positioning, at high precision, of the diffraction gratings to be accumulated for manufacture of an accumulation type diffraction grating.

Generally, for optical axis adjustment where two dioptric lenses are adhered to each other, the two adhered lenses may be rotated with respect to the optical axis so as to reduce the eccentric amount of the light transmitted. However, as regards a diffraction grating to be used as a diffraction lens, for example, since it uses its advantage of an achromatic effect, the focal length as a lens is long and, on the other hand, the eccentric amount of the light transmitted is small. Therefore, the optical axis adjustment method described above can not easily be used. Further, this method is not usable in the processes shown in FIGS. 2A-2I.

Each diffraction grating may be formed with an alignment mark so that the mark is registered with a certain reference. If this operation is made manually, the efficiency of adjustment becomes very low and it takes a very long time. If it is made automatically through image processing, the cost of necessary equipment increases and thus the production cost becomes high.

### SUMMARY OF THE INVENTION

It is an object of the present invention to provide a diffractive optical element having diffraction gratings positioned accurately.

It is another object of the present invention to provide a method of manufacturing a diffractive optical element having diffraction gratings positioned accurately.

In accordance with a first aspect of the present invention, there is provided a diffractive optical element having plural diffraction grating surfaces accumulated, characterized in that: a pair of diffraction grating surfaces are positioned so that a protrusion and/or a recess formed on an outside of one diffraction grating surface engages with a recess and/or a protrusion formed on an outside of the other diffraction grating surface; and that the pair of diffraction grating surfaces are defined on materials having different refractive indices and different dispersions and being formed into a kinoform, or a shape and a height of blazed or binary, close to it, such that a largest optical path difference to be applied to light rays passing through the diffraction grating surfaces with respect to plural wavelengths becomes equal to a multiple, by an integral number, of the wavelength.

In accordance with a second aspect of the present invention, there is provided a diffractive optical element having plural diffraction grating surfaces accumulated, characterized in that: a pair of diffraction grating surfaces are positioned so that a protrusion and/or a recess formed outside an optically effective region of one diffraction grating surface engages with a recess and/or a protrusion formed outside an optically effective region of the other diffraction grating surface; and that the pair of diffraction grating surfaces are defined on materials having different refractive indices and different dispersions and being formed into a kinoform, or a shape and a height close to it, such that a largest optical path difference to be applied to light rays passing through the diffraction grating surfaces with respect to each of plural wavelengths becomes equal to a multiple, by an integral number, of the wavelength.

In accordance with a third aspect of the present invention, there is provided a diffractive optical element having plural diffraction grating surfaces accumulated, characterized in that: a pair of diffraction grating surfaces are positioned so that a protrusion and/or a recess formed on an outside of one diffraction grating surface engages with a recess and/or a protrusion formed on an outside of the other diffraction grating surface; and that the pair of diffraction grating surfaces are defined on materials having different refractive indices and different dispersions and being formed into a kinoform, or a shape and a height close to it, such that a diffraction efficiency of diffraction light of a particular order, such as one of positive and negative first order, with respect to plural wavelengths, becomes equal to or nearly equal to 100%.

In accordance with a fourth aspect of the present invention, there is provided a diffractive optical element having plural diffraction grating surfaces accumulated, characterized in that: a pair of diffraction grating surfaces are positioned so that a protrusion and/or a recess formed outside an optically effective region of one diffraction grating surface engages with a recess and/or a protrusion formed outside an optically effective region of the other diffraction grating surface; and that the pair of diffraction grating surfaces are defined on materials having different refractive indices and different dispersions and being formed into a kinoform, or a shape and a height close to it, such that a diffraction efficiency of diffraction light of a particular order, such as one of positive and negative first order, with respect to plural wavelengths, becomes equal to or nearly equal to 100%.

In one preferred form of these aspects of the present invention, the pair of diffraction gratings are disposed opposed to each other with a space such as by an air interposed therebetween.

In a further preferred form of theses aspects of the present invention, the protrusion and the recess have a sectional shape of one of a triangle shape, a trapezoidal shape and a semi-circular shape.

In accordance with a fifth aspect of the present invention, there is provided a diffractive optical element having plural diffraction grating surfaces accumulated, characterized in that: a pair of diffraction grating surfaces are mutually positioned so that a protrusion and/or a recess having a sectional shape of one of a triangular shape, a trapezoidal shape, and a semi-circular shape, formed on one diffraction grating surface, engages with a recess and/or a protrusion having a sectional shape of one of a triangular shape, a trapezoidal shape, and a semi-circular shape, formed on the other diffraction grating surface.

In accordance with a sixth aspect of the present invention, there is provided a diffractive optical element having plural diffraction grating surfaces accumulated, characterized in that: a pair of diffraction grating surfaces are mutually positioned so that a protrusion and/or a recess having a sectional shape of one of a triangular shape, a trapezoidal shape, and a semi-circular shape, formed outside an optically effective region of one diffraction grating surface engages with a recess and/or a protrusion having a sectional shape of one of a triangular shape, a trapezoidal shape, and a semi-circular shape, formed outside an optically effective region of the other diffraction grating surface.

In accordance with a seventh aspect of the present invention, there is provided a method of manufacturing a diffractive optical element as any one of them recited above, wherein it includes a process for fitting the protrusion as formed on the one diffraction grating into the recess as formed on the other diffraction grating.

In accordance with an eights aspect of the present invention, there is provided a method of manufacturing a diffractive optical element as any one of them recited above, wherein it includes a process in which, after one diffraction grating surface is formed, another diffraction grating surface is formed by use of a mold, wherein a protrusion and/or a recess formed on the one diffraction grating surface is fitted into a recess and/or a protrusion formed on the mold for the other diffraction grating surface, whereby these diffraction grating surfaces are mutually positioned and molding of the other diffraction grating surface is performed.

In accordance with a ninth aspect of the present invention, there is provided a method of manufacturing a diffractive optical element, comprising the steps of: forming, upon a substrate, a first diffraction grating and a recess and/or a protrusion; preparing a mold having a protrusion and/or a recess to be engaged with the recess and/or the protrusion formed on the substrate, as well as a second diffraction grating pattern; and positioning the diffraction grating on the substrate and the diffraction grating pattern with each other by engaging the recess and/or the protrusion of the substrate with the protrusion and/or the recess of the mold.

In accordance with a tenth aspect of the present invention, there is provided an optical system having a diffractive optical element as manufactured in accordance with a method of the ninth aspect of the present invention described above.

In accordance with a further aspect of the present invention, there is provided an optical system having a diffractive optical element according any one of the aspects of the present invention described above.

In accordance with a yet further aspect of the present invention, there is provided an optical system having a diffractive optical element as manufactured in accordance with a method of any one of the aspects of the present invention described above.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIGS. 1A-1J are schematic and sectional views for explaining manufacturing processes for a mono-layer step-like diffraction grating.

FIGS. 2A-2I are schematic and sectional views for explaining manufacturing processes for an accumulation type step-like diffraction grating.

FIG. 3 is a schematic and sectional view for explaining a diffractive optical element according to an embodiment of the present invention.

FIGS. 4A-4E are schematic and sectional views for explaining manufacturing processes for the diffractive optical element of FIG. 3.

FIGS. 5 and 6 are schematic views, respectively, for explaining alignment marks.

FIG. 7 is a schematic and sectional view of a diffractive optical element having accumulated diffraction gratings of glass and resin.

FIG. 8 is a schematic and sectional view of a diffractive optical element having accumulated blazed-type diffraction gratings.

FIG. 9 is a front view of a diffractive optical element according to an embodiment of the present invention.

FIG. 10 is a schematic and front view of a camera with a diffractive optical element according to an embodiment of the present invention.

FIG. 11 is a schematic and side view of the camera of FIG. 10.

FIG. 12 is a schematic and sectional view of an accumulation type diffractive optical element according to an embodiment of the present invention.

FIG. 13 is an enlarged section of an outer peripheral portion of an accumulation type diffractive optical element.

FIG. 14 is a schematic and sectional view of a mold.

FIG. 15 is an enlarged section of an outer peripheral portion of a mold.

FIG. 16 is a schematic and sectional view of a mold.

FIG. 17 is an enlarged section of an outer peripheral portion of a mold.

FIG. 18 is a schematic view for explaining resin setting means.

FIG. 19 is a sectional view of a glass substrate and a diffraction grating.

FIG. 20 is a sectional view of a mold and an accumulation type diffractive optical element, according to another embodiment of the present invention.

FIG. 21 is a sectional view of an accumulation type diffractive optical element.

### DESCRIPTION OF THE PREFERRED EMBODIMENTS

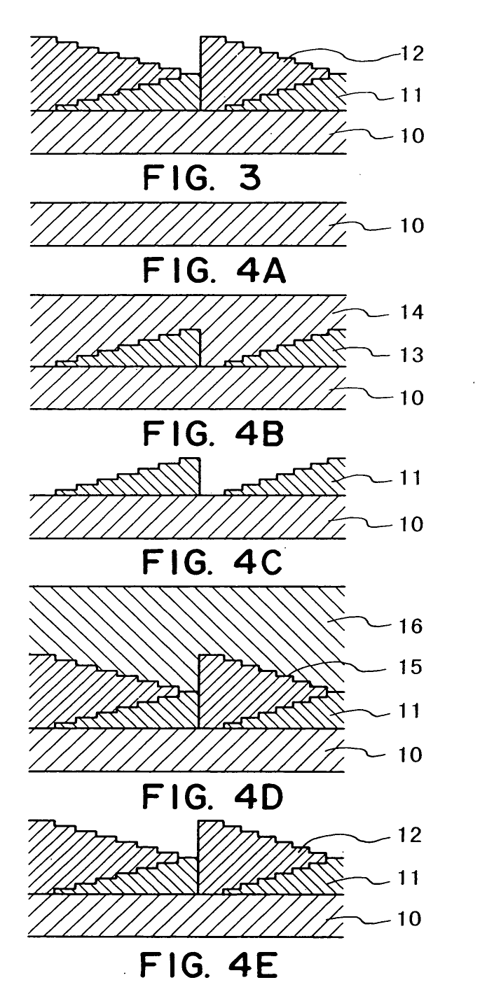

Preferred embodiments of the present invention will now be described, first with reference to FIGS. 3-11 of the accompanying drawings.

FIG. 3 is a sectional view of a diffractive optical element (diffraction type lens) of eight-level step-like structure according to a first embodiment of the present invention. There is a glass substrate 10 on which a first diffraction grating (first periodic structure) 11 is formed. There is a second diffraction grating (second periodic structure) 12 formed on the first diffraction grating 11. The first diffraction grating 11 is formed by molding a photo-setting resin containing, as a main component, denatured epoxyacrylate having a high refractive index and a large dispersion. The second diffraction grating 12 is formed by molding an acrylate series ultraviolet radiation setting resin of low dispersion. As regards the selection of these resins, it is determined in accordance with the combination of two or more resin materials, on the basis of optical design. Thus, depending on the use, an appropriate selection can be done and, additionally, the order of accumulation can be selected as desired.

The following resins may be used as a design example of a diffractive optical element according to this embodiment.

First Layer Material:

Main Component: denatured epoxyacrylate
Refractive Index after Setting: 1.598
Abbe Constant: 28
   Second Layer Material:
Main Component: urethane denatured polyester acrylate
Refractive Index after Setting: 1.525
Abbe Constant: 50.8

Here, in order to provide a grating structure with which light of a used wavelength region is concentrated to a particular order, it is necessary that a high diffraction efficiency (100% or approximately 100%) is obtained with respect to C-line of a wavelength 486.13 mm and F-line of a wavelength 656.27 nm, for example. To this end, the diffraction gratings should satisfy the following conditions.
656.27/8=|(Na_{F}−1)·dₐ−(Nb_{F}−1)·d_{b}|
486.13/8=|(Na_{C}−1)·dₐ−(Nb_{C}−1)·d_{b}|
where
Na_{F} is the refractive index of the first layer with respect to the F-line;
Nb_{F} is the refractive index of the second layer with respect to the F-line;
Na_{C} is the refractive index of the first layer with respect to the C-line;
Nb_{C} is the refractive index of the second layer with respect to the C-line;
dₐ is the height (level difference) of the diffraction grating of the first layer; and
d_{b} is the height (level difference) of the diffraction grating of the second layer.

An example of the shape and size satisfying these conditions may be:
dₐ=2355 nm
d_{b}=2818 nm

FIGS. 4A-4E are sectional views for explaining manufacturing processes for a diffractive optical element such as shown in FIG. 3. First, in FIG. 4A, the surface of a quartz glass substrate 10 on which a first diffraction grating 12 is to be formed is coated uniformly with silane coupling, by using a spinner. Then, it is dried in an oven. The coupling has a function that, in the mold releasing, the adherence between the substrate 10 of quartz glass and the resin material 13 of the first layer (FIG. 4B) becomes larger than the exfoliation property between a quartz first mold 14 of the first layer and the resin material 13 of the first layer, such that the molded resin material 13 is sufficiently fixed on the quartz glass substrate 10.

In FIG. 4B, the first mold 14 of quartz glass is used to perform the molding to provide a quartz glass with a step-like diffraction grating shape, and ultraviolet radiation is projected thereto to set the same. Then, as the first mold 14 is released, a first diffraction grating 11 such as shown in FIG. 4C is produced.

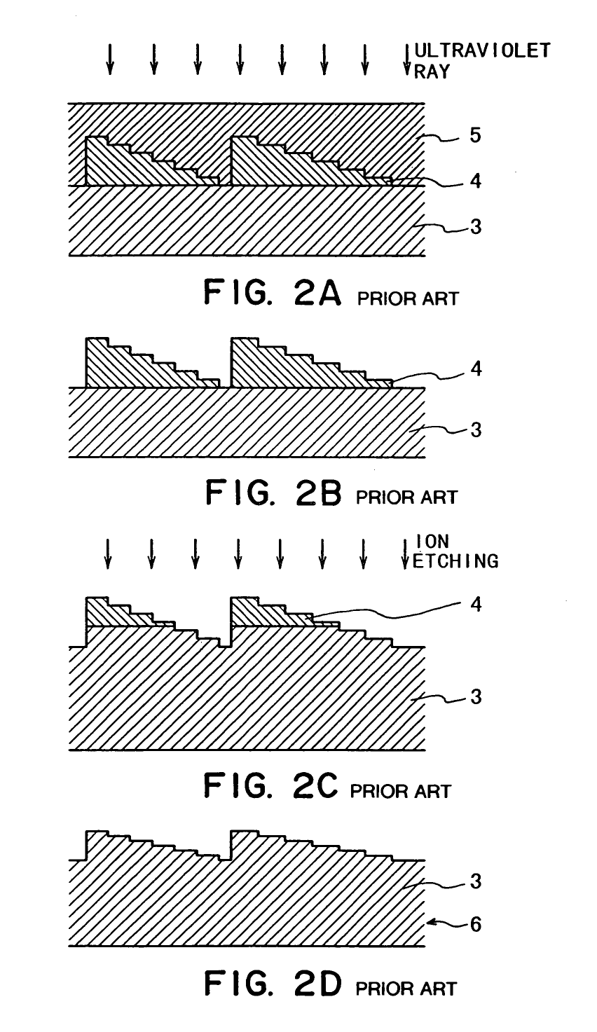

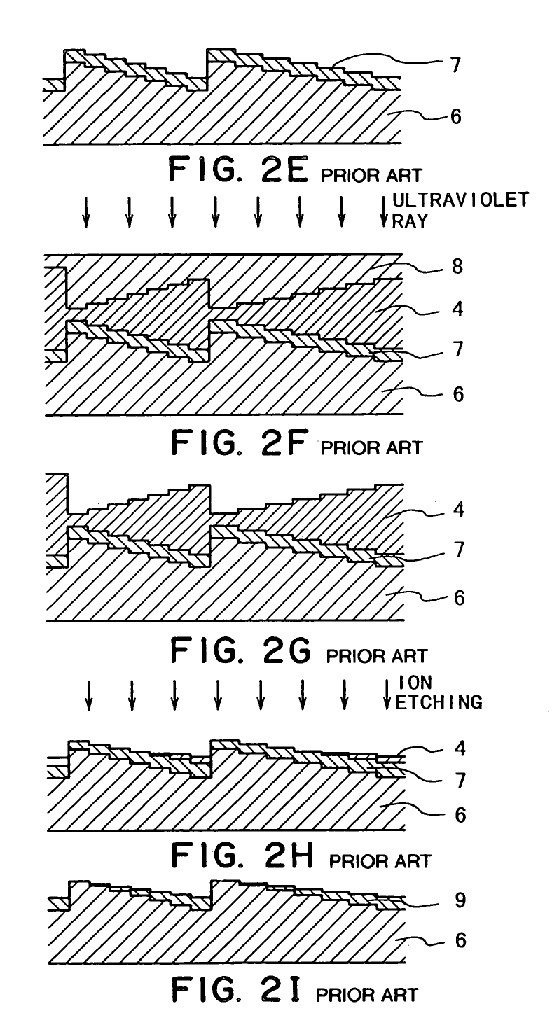

Subsequently, in FIG. 4D, a second-layer resin material 15 is put on the first diffraction grating 11. By using a second mold 16, it is molded and then is set, in a similar manner as described above. By this, a dual-layer composite diffraction grating such as shown in FIG. 2E is produced.

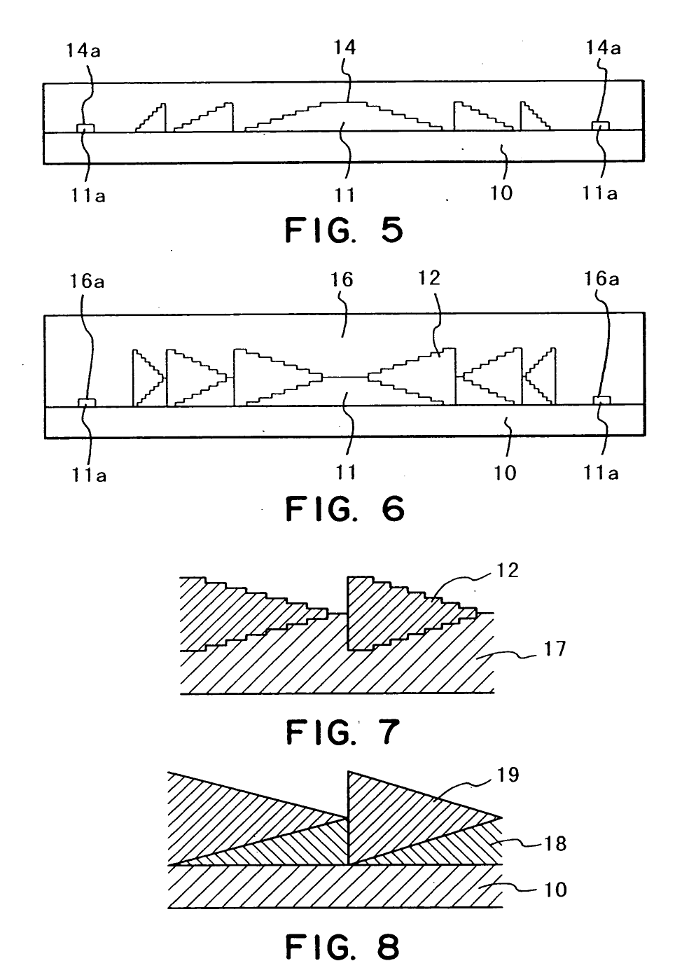

The second-layer diffraction grating 12 should be aligned with the first-layer diffraction grating 11 very precisely. If there is any misalignment therebetween, not only the diffraction efficiency enhancement effect to be obtained by designing diffraction gratings in the unit of pitch degrades but also the diffraction itself is disturbed such that the correct function is lost. In consideration of it, in this embodiment, as shown in FIGS. 5 and 6, alignment marks 11a are transferred to the substrate 10 in the molding of the first layer, on the basis of recesses 14a formed in the first mold 14. Then, by registering recesses 16a of the second mold 16 with respect to these marks, high precision alignment is accomplished.

If, in the molding of the second layer diffraction grating 12, the thickness of its optical resin material 15 is smaller than the height of the first layer diffraction grating 11, since the second mold 16 should be fitted with the grating structure of ultraviolet radiation setting resin material on the quartz substrate, the accurateness of alignment and the setting of fitting size are difficult to accomplish. Additionally, there is a possibility that the second mold 16 and the first layer diffraction grating 11 are damaged. In order to avoid this, since in the design of a diffractive optical element the order of layers is theoretically not influential, a layer of smaller grating height may be placed on the bottom ground side.

The second layer diffraction grating 12 has to be completely and intimately contacted to the first layer diffraction grating 11 after the mold releasing. Therefore, in order that the resin materials have sufficient adhesion strength against the mold releasing, a mold releasing agent application treatment may be made to the mold to improve the mold releasing property. In the mold releasing operation, a particular note should be paid to assure that, after the sample is placed in a sufficiently diluted releasing agent, vapor washing or the like is made to prevent that an excessive releasing agent disturbs the fine shape.

The thickness of the resins being molded in two layers is practically larger than the total thickness of the layers. Even through heating to decrease the viscosity or through pressure molding, it does not reach the thickness of only the diffraction grating portion. However, if the thickness is uniform over the grating surface, the influence to the whole light flux passing therethrough is even and, thus, there is no inconvenience in the performance as a diffraction grating. It is therefore important to make the thickness of each layer uniform. Further, since in a diffractive optical element of short focus, the picture angle becomes large. If, therefore, the resin thickness is large, due to the picture angle, the direction of light shifts within the element such that the diffraction efficiency enhancement effect reduces. For this reason, it is important that the resin thickness is kept small as much as possible and that the element design is made while fully taking into account the picture angle and the resin thickness.

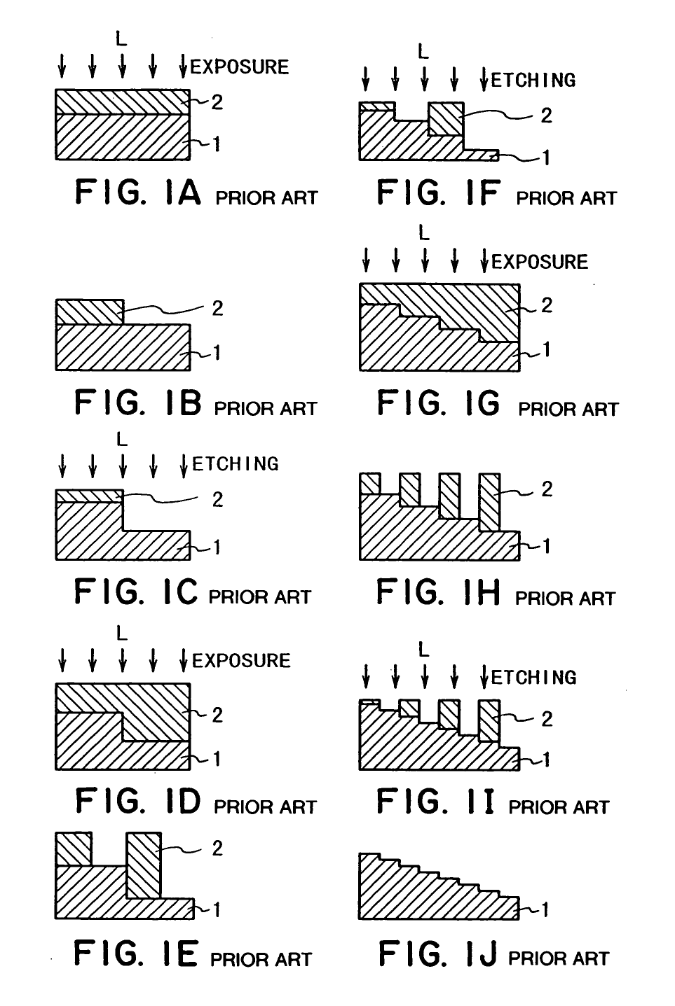

The quartz mold for the resin material can be manufactured through a photolithographic process. For example, in a case where the shape of the mold to be transferred is a step-like grating, as in the example of FIGS. 1A-1J, it may be produced while repeating the photolithographic process plural times. Generally, since a resin of high refractive index has a low weathering resistance, a relatively stable resin should desirably be used as the second layer to hold the performance.

FIG. 7 is a sectional view of a second embodiment, wherein a replica diffraction grating 12 is formed on a diffraction grating 17 which is defined by etching a lanthanum glass.

First Layer Material:

Main Component: lanthanum glass
Refractive Index: 1.678
Abbe Constant: 55.3
   Second Layer Material:
Main Component: denatured epoxyacrylate
Refractive Index after Setting: 1.598
Abbe Constant: 28

As regards the process for the lanthanum glass, there are a photographic method and a method in which a coating material is applied to a lanthanum glass substrate and in which anisotropic etching is made thereto to transfer the shape to the lanthanum glass surface. The latter may be advantageous in respect to the productivity. In any of these methods, a diffraction grating 17 is formed and, additionally, alignment marks 11a such as shown in FIG. 5 or 6 are formed in a portion other than the diffraction grating 17. By registering the mold for the replica diffraction grating 12 with these alignment marks, high precision alignment is accomplished.

Like the first embodiment, a second diffraction grating is formed by using a resin. Here, the shape that satisfies the diffraction efficiency enhancement condition is such as follows.
Level Difference (Step Height) of First Layer Diffraction Grating dₐ=2042 nm
Level Difference (Step Height) of First Layer Diffraction Grating dₐ=2204 nm

It is to be noted that, in regard to glass materials other than the lanthanum glass, a desired diffractive optical element can be produced through a similar optical design.

Further, it can be applied to a diffractive optical element having accumulation of two layers of blazed type (Kinoform) gratings, such as shown in FIG. 8. Where the following relation is satisfied with respect to the combination of materials as in the first embodiment, the effect of dual layers as has been described hereinbefore can be retained.
mλ_{D}=(Na_{D}−1)·dₐ−(Nb_{D}−1)·d_{b}
mλ_{F}=(Na_{F}−1)·dₐ−(Nb_{F}−1)·d_{b}
mλ_{C}(Na_{C}−1)·dₐ−(Nb_{C}−1)·d_{b}
where _{D}, _{F} and _{C} are the wavelengths of the D-line, F-line and C-line, respectively, and Nb_{D} is the refractive index of the second layer with respect to the D-line.

In an embodiment, the following heights are set, and a mold is made by cutting, by using a diamond bite.
First Layer Grating Height: h₁=21.07 micron
Second Layer Grating Height: h₂=22.54 micron

FIG. 8 is a sectional view of a diffractive optical element of chopping-wave shape, according to a third embodiment. In the diffractive optical element of the second embodiment wherein the replica diffraction grating 12 is formed on the diffraction grating 17 defined by etching a lanthanum glass, a diffraction grating 18 of chopping-wave shape, in place of the step-like grating shape, is formed. As regards the micro-processing of a glass, after a photoresist is formed into a chopping wave shape as calculated from the etching rate, anisotropic etching is performed to accomplish it. Subsequently, like the second embodiment, a second diffraction grating 19 is molded by using a resin.

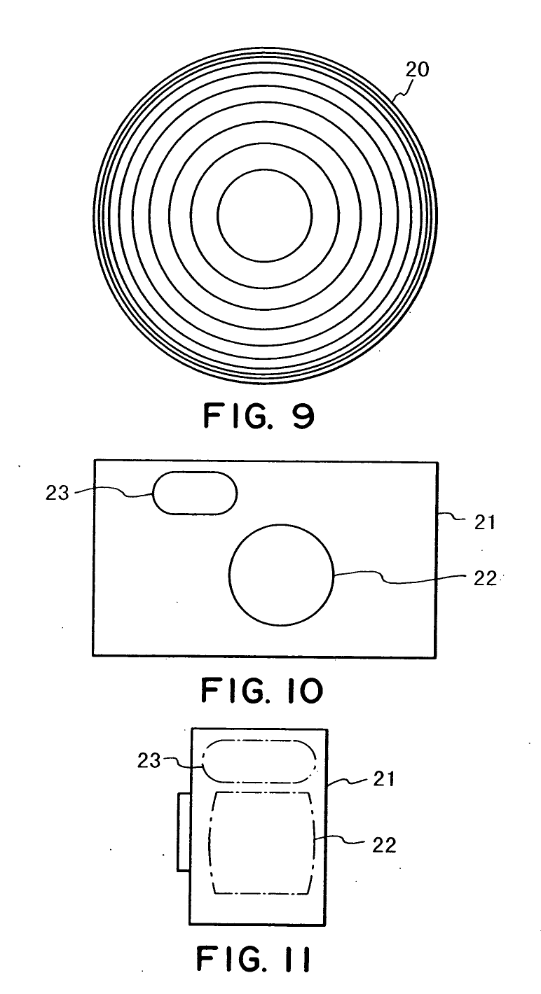

FIG. 9 is a front view of a diffractive optical element 20 according to any one of the embodiments described hereinbefore. In one grating, only the boundaries of each are illustrated by solid lines, and the boundary lines of the step-like structure in each grating pitch are omitted in illustration. With this dual-layer diffractive optical element 20, the diffraction efficiency of diffraction light of the design order can be improved over the whole used wavelength region. Therefore, a superior optical performance can be provided. While in this example a saw-tooth section (Kinoform) as approximated by an eight-level step-like structure is illustrated, the element can be manufactured through approximation other than with eight levels, such as four levels or sixteen levels, for example.

FIG. 10 is a front view of a camera having a diffractive optical element 20. FIG. 11 is a side view of this camera. The main body 21 of the camera has a photographic optical system 22 and a finder optical system 23. The diffractive optical element 20 can be provided at a desired position in the photographic optical system 32 or the finder optical system 33. Use of the diffractive optical element 20 in an optical system of an optical instrument such as a camera, for example, like the example described above, the optical performance of the optical instrument can be improved.

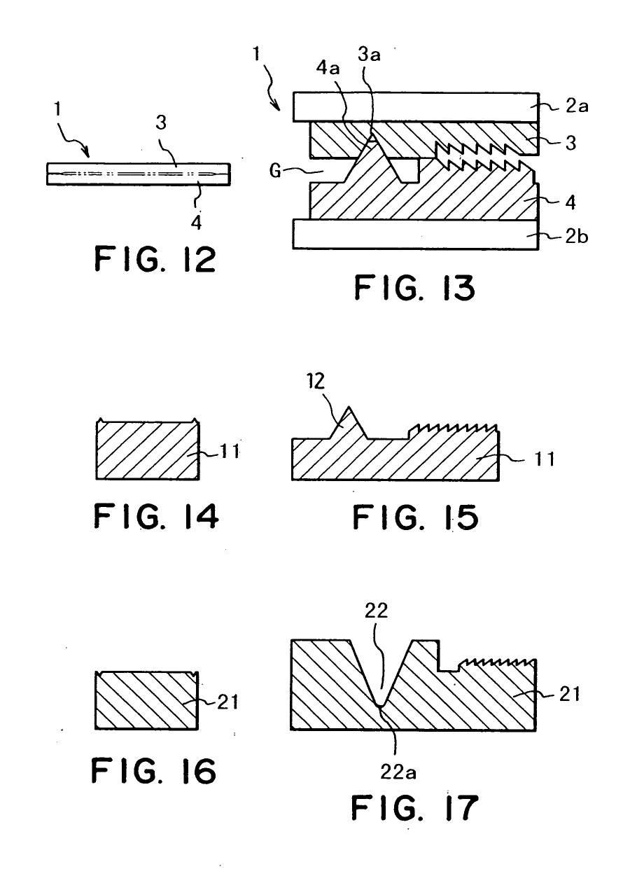

Further embodiments of the present invention will be described in conjunction with FIGS. 12-21.

FIG. 12 is a sectional view of an accumulation type diffractive optical element 101 according to a fourth embodiment of the present invention. FIG. 13 is an enlarged section of an outer peripheral portion of this diffractive optical element 101. The diffractive optical element 101 comprises a diffraction grating 103 which is made of a resin and is formed on a glass substrate 102a, and another diffraction grating 104 which is made of a different resin with the same pitch as the grating 103 and is adhered to a glass substrate 102b. Between these diffraction gratings 103 and 104, there is an air gap G of 1.5 micron.

The diffraction gratings 103 and 104 of this embodiment have a blazed Kinoform grating shape. The diffraction grating 103 is made of a photo-setting resin having a high refractive index and a large dispersion, while the diffraction grating 104 is made of a photo-setting resin having a low refractive index and a small dispersion. As regards the selection of these resins, a combination or two or more resin materials may be determined on the basis of optical design.

Also, the grating shape such as grating height and pitch, for example, is dependent upon the use and the material. The grating shape may be a step-like shape called a binary shape, for example.

As regards the resin material of the diffraction grating 103 of this embodiment, methacrylate series ultraviolet radiation setting resin is used. The refractive index thereof after being set is 1.635, and its Abbe constant is 23. As regards the resin material of the diffraction grating 104, an urethane denatured polyester acrylate series ultraviolet radiation setting resin is used. The refractive index thereof after being set is 1.525, and its Abbe constant is 50.8.

In an accumulation type diffractive optical element 101 to be used in an optical instrument such as a camera, for example, the grating shapes have to be determined in regard to the respective materials so that, with respect to the light of the used wavelength region such as c-line of a wavelength λ=565.27 nm and g-line of a wavelength λ=435.83 nm, for example, the light is concentrated to a particular order (usually, one of positive and negative first orders, but other orders are possible) and a high diffraction efficiency (95-100%) is accomplished. The gratings of the diffraction gratings 103 and 104 are so determined that a largest optical path difference to be applied to the light rays passing through them becomes equal to a multiple, by an integral number, of the wavelength, with respect to the light of plural wavelengths of c-line and g-line. As regards specific design examples for the determination, reference may be made to Japanese Laid-Open Patent Application, Laid-Open No. 448100/1999. In this embodiment, the diffraction grating 103 has a grating height of 6.74 microns, while the diffraction grating 104 has a grating height of 9.50 microns. Also, the grating pitch of the periodic structure that produces the diffraction effect becomes smaller as the distance away from the center of the diffraction grating. The smallest pitch is about 40 microns. The diffraction gratings 103 and 104 have the same pitch. They engage with each other, at recesses 103a and protrusions 104a which are formed around and outside of the optically effective regions of them, in a ring-like shape or at three or more locations.

FIG. 14 is a sectional view of a mold 111 for producing the diffraction grating 103. FIG. 15 is an enlarged view of an outer peripheral portion of this mold 111. This mold 111 is produced by KN plating a super steel with a film thickness of several tens microns and then by cutting the plating film by use of a diamond bite. At the outside of the optically effective region of the mold 111, there is a protrusion 112 for defining the recess 103a, which is formed by a cutting operation.

Similarly, FIG. 16 is a sectional view of a mold 121 for producing the diffraction grating 104. FIG. 17 is an enlarged view of an outer peripheral portion of this mold 121. At the outside of the optically effective region of it, there is a recess 122 for defining the protrusion 104a. The positions of the protrusion 112 and the recess 122 from the center of the diffraction lens should be the same also in the diffraction grating. Through practical cutting operations, the difference of them can be 1 micron or less.

As regards the protrusion 112 and the recess 122, an ordinary method is to mate a V-shaped section with a semi-circular shape. Practically, however, the positioning at the contact between a plane and a circle is difficult in respect to the machining or in the point of gap setting between the diffraction gratings. In consideration of it, in this embodiment, the protrusion 112 is formed into a roof-like shape, while the recess 122 is formed into a V-shaped groove. There is a flat portion 122a of 5 microns at the bottom of the V-shaped groove, this being to avoid breakage of the molded article. The sectional shapes of the protrusion 104a, recess 103a, recess 122 and protrusion 112 are not limited to a triangular shape such as illustrated, but they may be a trapezoidal shape or semi-circular shape.

First, drops of a methacrylate series ultraviolet radiation setting resin, for providing a diffraction grating, of an amount controlled by a dispenser are applied onto the center of the molding surface of the mold 11. However, with a grating shape of a pitch 40 microns and a grating height 10 microns, airs are forced into the fine shape as the resin is diffused along the mold 111, causing a fault in shape of the molded article. In consideration of it, as the resin is diffused up to the protrusion 112 outside the optically effective region of the mold, de-foaming treatment may preferably be made in a vacuum container, with a reduced pressure of about 10 mmHg.

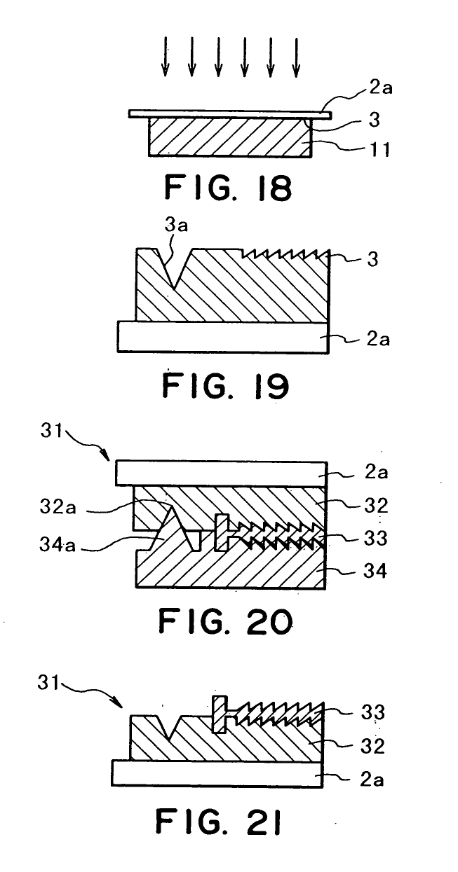

After such de-foaming treatment, as shown in FIG. 18, a very small amount of resin is applied, by drops, to the center of the glass substrate 102 which serves as a substrate of a molded article, and this resin is contacted to the resin on the mold 111. The glass substrate 102a is gradually moved down, and then it is held fixed at the position that assures a desired thickness.

Subsequently, since the resin material used in this embodiment is a photo-setting resin, ultraviolet rays are projected from the glass substrate 2a side to thereby temporally set the resin. Then, the periphery of the glass substrate 102a is pulled up, whereby the substrate is released from the mold together with the diffraction grating 3. By this, as shown in FIG. 19, a diffraction grating 103 with a recess 103a can be produced on the glass substrate 102a. For enhanced adhesion with the resin, the glass substrate 102a is coated with a silane coupling beforehand, by using a spinner, and after that, it is dried in an oven.

Similar sequential operations are made while using an urethane denatured polyester acrylate series ultraviolet radiation setting resin as the mold 121, and a diffraction grating 104 with a protrusion 4a can be produced upon the glass substrate 102b (FIG. 12).

Since, in the molding method of this embodiment, as the resin is set, the diffraction gratings 103 and 104 as well as the glass substrates 102a and 102b as a whole are deformed by contraction, there is a limitation in regard to the thicknesses of the resin and glass substrates 102a and 102b. In this embodiment, the film thickness of the resin is 50 microns and, thus, the height of the protrusion/recess is made equal to 80 microns.

Subsequently, one of the diffraction gratings 103 and 104 produced in accordance with the method described above is held fixed by using a fixing tool. A thioxotropy series photo-setting adhesive agent of low fluidity is applied, by drops, to plural locations outside the recess 103a or protrusion 104a and along a circumferential direction. The other diffraction grating is then placed to face the molding surface side, and they are put together with their centers aligned. By this, an accumulation type diffractive optical element 101 having an accumulated layer structure is produced. Here, an interference fringe can be observed in the diffraction gratings 103 and 104, such that the rough adjustment for the centering may be done on the basis of it. Subsequently, after they are combined so that the circles of the recess 103a and protrusion 104a are registered with each other, ultraviolet rays are projected for the setting, whereby the accumulation type diffractive optical element 101 can be completed.

FIG. 20 is a sectional view of an accumulation type diffractive optical element 131 according to a fifth embodiment of the present invention. While in the preceding embodiment two diffraction gratings 103 and 104 are adhered with each other to produce a diffractive optical element 101 of accumulated layer structure, in this embodiment a second layer diffraction grating 133 is directly accumulated upon a first layer diffraction grating 132 whereby an accumulation diffractive optical element 131 is produced.

Where accumulation molding is to be made, if in the molding of the second layer diffraction grating 133, the thickness of the second layer resin is smaller than the height of the first layer diffraction grating 132, there is a possibility that the mold 134 and the first layer diffraction grating 132 is broken. In consideration of it, the diffraction grating of lower grating height is formed in the first layer at the bottom base side. Also, since in the design of an optical element, theoretically there is no dependency upon the order of layers accumulated, any optical element may be placed above without inconvenience.

First, like the preceding embodiment, a mold (not shown) is used to form a diffraction grating 132 on the glass substrate 102. Also, a recess 132a is formed outside the optically effective region of the diffraction grating 132 on the glass substrate 102. The height of the grating shape of the mold 134 for forming a diffraction grating 133 is set to 2.76 microns, as subtracting the grating height of the diffraction grating 132, and a protrusion 134a like the first embodiment is provided.

Then, by engaging the recess 132a formed on the diffraction grating 132 and the protrusion 134a provided on the mold 134, the positioning of the mold 134 can be accomplished. By injecting a resin into the gap between the diffraction grating 132 and the mold 134, a diffraction grating 133 can be produced. Thereafter, as shown in FIG. 21, the mold 134 is released, whereby diffraction gratings 132 and 133 can be formed in accumulation upon the glass substrate 102.

After release from the mold 134, the diffraction grating 133 should be intimately adhered to the first layer diffraction grating 132. While the adhesion between the diffraction gratings 132 and 133 needs an adhesion strength of a level that prevents releasing, as regards the mold 134, a particular note should be paid to perform a mold releasing treatment to improve the releasing property, wherein it is placed in a sufficiently diluted mold releasing agent beforehand and then it is vapor washed, for example, so that excessive mold releasing agent disturbs the fine shape.

Generally, the thickness of the diffraction grating 133 molded in the second layer becomes large. Even through heating to decrease the viscosity or through pressure molding, it does not reach zero in the region other than the grating pitch. However, if the film thickness is uniform over the diffractive optical element 131, the influence to the whole light flux passing therethrough is even and, thus, there is no inconvenience in the performance as a diffraction optical element 131. It is rather important to make the film thickness uniform. Since in an optical element of short focus, the picture angle becomes large, if the resin thickness is large, due to the picture angle, the direction of light shifts within the element such that the correction effect reduces. For this reason, it is important that the resin film thickness is kept small as much as possible and that the element design is made while fully taking into account the picture angle and the resin thickness.

While in the fourth and fifth embodiments the recess or protrusion of the mold is formed by machining, it is not practically easy to machine it at high precision. In consideration of it, first, a mold for any one of the recess or protrusion for the mating may be formed by cutting. The thus produced mold for the recess or protrusion may then be transferred by using a photo-setting resin, for example, upon a glass substrate. Thereafter, a deposition film may be formed upon the surface of the molding article and, through nickel plating, an electroformed article is produced. Subsequently, a fine shaping may be made to the optically effective region of a mold of the recess or protrusion having been molded first. Also, a similar micro-processing may be made to the surface of the electroformed article, completed. Here, by providing a mark at the center so as to enable correct adjustment of the center position, a mold can be completed.

While the invention has been described with reference to the structures disclosed herein, it is not confined to the details set forth and this application is intended to cover such modifications or changes as may come within the purposes of the improvements or the scope of the following claims.

1-14. (canceled)

15. A diffractive optical element, comprising by a diffraction grating portion which includes first and second transparent diffraction gratings, wherein the first transparent diffraction grating, a first alignment pattern and a first contact portion are integrally formed on a first substrate by molding, and wherein the second transparent diffraction grating, a second alignment pattern and a second contact portion are integrally formed on a second substrate by molding,
wherein the first and second transparent diffraction gratings are disposed opposed to each other and accumulated with an air space of a predetermined distance defined by superimposing the first and second contact portions with each other, and
wherein the first alignment pattern engages with the second alignment pattern.

16. A diffractive optical element according to claim 15, wherein the first and second alignment patterns are transparent, and the first and second contact portions are transparent.

17. A diffractive optical element according to claim 15, wherein the first transparent diffraction grating, the first alignment pattern and the first contact portion are made of a first resin, and the second transparent diffraction grating, the second alignment pattern and the second contact portion are made of a second resin having an Abbe number different from that of the first resin.

18. An optical system, comprising:
a lens; and
a diffractive optical element as recited in claim 15.
